(19) United States
(12) Patent Application Publication
(10) Pub. No.: US 2009/0008867 A1
(43) Pub. Date: Jan. 8, 2009

(54) RECORDING MEDIUM TRAY ASSEMBLY/DISASSEMBLY MECHANISM AND IMAGE FORMING APPARATUS

(75) Inventor: Hideaki KAWADA, Yokohama (JP)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/049,570

(22) Filed: Mar. 17, 2008

(30) Foreign Application Priority Data
Jul. 5, 2007 (JP) 2007-177584
Aug. 31, 2007 (KR) 2007-88298

(51) Int. Cl. B65H 1/00; B41F 13/00

(52) U.S. Cl. 271/153; 270/1.01

(57) ABSTRACT

A recording medium tray assembly/disassembly mechanism to assemble/disassemble a recording medium tray with respect to an image forming apparatus includes a sensor to detect an accommodation operation or an ejection operation of the recording medium tray with respect to the image forming apparatus, and a drive mechanism to accommodate the recording medium tray at an accommodation complete position or ejecting the recording medium tray from the accommodation complete position by being driven according to the detection by the sensor.

### CROSS-REFERENCE TO RELATED APPLICATIONS

This application claims priority under 35 U.S.C. §119(a) from Japanese Patent Application No. 2007-177584, filed on Jul. 5, 2007, in the Japan Patent Office, and Korean Patent Application No. 10-2007-0088298, filed on Aug. 31, 2007, in the Korean Intellectual Property Office, the disclosures of which are incorporated herein in their entirety by reference.

### BACKGROUND OF THE INVENTION

1. Field of the Invention

The present general inventive concept relates to a recording medium tray assembly/disassembly mechanism and an image forming apparatus including the recording medium tray assembly/disassembly mechanism.

2. Description of the Related Art

An image forming apparatus, such as a copier or printer, includes a paper tray for containing sheets of paper that can be drawn by a main body of the apparatus. When the image forming apparatus is out of paper, the paper tray is ejected and inserted again in the image forming apparatus after supplying the paper tray with new paper. The paper tray is driven by a drive unit, such as a motor.

However, although conventional technology assumes that the paper tray is driven by a drive unit, such as a motor or a gear, a drive mechanism is not configured assuming that the paper tray can be disassembled from an image forming apparatus. According to Japanese Patent Publication Nos. hei 5-238565, hei 5-270669, and hei 5-278874, since the paper tray is not assumed to be able to be disassembled from the main body of an image forming apparatus, gears are not stably engaged when the disassembled paper tray is reinstalled in the apparatus. Also, according to Japanese Patent Publication Nos. 2005-178925 and 2005-263346, even though the insertion of the paper tray is performed by a drive unit, the ejection of the paper tray is manually carried out instead of by the drive unit.

In a general image forming apparatus having a paper tray installed therein, the paper tray is supported by a support unit, which is provided in the image forming apparatus, to prevent the paper tray from separating from the image forming apparatus. However, when the paper tray is pushed into the general image forming apparatus, since the support unit and the paper tray interfere with each other, a change in a force to push the paper tray is generated. Such a problem will be described in detail with reference to FIGS. 22-25. As illustrated in FIG. 22, a paper tray 600, loaded in a main body of an image forming apparatus 500, is locked in the main body since a support unit 510 (hereinafter referred to as “catch 510”), fixed to the image forming apparatus 500, is coupled to a coupling portion 610 of the paper tray 600. A spring such as a metal spring or a plastic spring is generally used as the catch 510.

According to the sequential order of FIGS. 23 (A)-(D), when the recording medium tray 600 is pushed into the main body, the coupling portion 610 of the recording medium tray 600 enters into an opening 510a of the catch 510, and the catch 510 expands outward as the coupling portion 610 enters into the opening 510a. Since the catch 510 returns to an original state once the coupling portion 610 passes a dead point illustrated in FIG. 23C, a force from pushing the recording medium tray 600 into the main body of the image forming apparatus 500 acts on the recording medium tray 600. Then, the coupling portion 610 of the recording medium tray 600 is accommodated in the opening 510a of the catch 510 and the recording medium tray 600 is supported in the image forming apparatus 500.

FIG. 24 is a graph illustrating the changes of an insertion force to insert the recording medium tray 600 according to elasticity of the catch 510. As illustrated in FIG. 24, when the recording medium tray 600 moves in an insertion direction, only resistance due to a frictional force acts on the recording medium tray 600 until the coupling portion 610 contacts the catch 510. When the coupling portion 610 contacts the catch 510, the catch 510 expands outward so that the coupling portion 610 enters into the opening 510a of the catch 510. Accordingly, the insertion force is rapidly increased. Then, when the coupling portion 610 passes the dead point, since the catch 510 that has elastically expanded returns to the original state, the recording medium tray 600 is drawn into the main body. Thus, the insertion force is rapidly decreased to be a negative force. To complete the insertion of the recording medium tray 600 over the dead point, a force exceeding an insertion force F illustrated in FIG. 24 is needed. When the recording medium tray 600 reaches an accommodation complete position and the accommodation operation is complete, the coupling portion 610 is supported in the opening 510a of the catch 510. In this state, a support force H by the catch 510 is generated. When the recording medium tray 600 is to be ejected from the main body, an ejection force exceeding the support force H is needed.

FIG. 25 is a graph illustrating changes of an ejection force to eject the recording medium tray 600 according to the elasticity of the catch 510. When an ejection force, to eject the recording medium tray 600, exceeds the support force H of the catch 510, the recording medium tray 500 is displaced in an ejection direction. When the recording medium tray 600 is ejected, since the coupling portion 610 expands the opening 510a of the catch 510 as the coupling portion 610 is ejected from the catch 510 and before the dead point, the ejection force is rapidly increased. Then, once the coupling portion 610 passes the dead point, the catch 510 that expanded outward returns to the original state, and thus, the recording medium tray 600 is ejected from the recording medium tray 600. Accordingly, the ejection force applied to the recording medium tray 600 is rapidly decreased to be a negative force. To complete the ejection of the recording medium tray 600 over the dead point, an ejection force exceeding a withdrawal force F, illustrated in FIG. 25, is needed. When the coupling portion 610 of the recording medium tray 600 is separated from the catch 510a, only the resistance due to a friction force is applied to the recording medium tray 600 so that the ejection force becomes a constant ejection force.

When the recording medium tray 600 is inserted in or ejected from the image forming apparatus 500, a force due to expansion of the catch 510, which is generated as the coupling portion 610 of the recording medium tray 600 is coupled to the catch 510 or the coupling portion 610 is separated from the catch 510, is applied to the recording medium tray 600. Thus, an insertion force or ejection force of the recording medium tray 600 changes greatly. As a result, when the catch 510 and the coupling portion 610 are coupled to each other or the catch 510 is separated from the coupling portion 610, a great force is needed to manipulate the recording medium tray 600 into/out of the apparatus.

Also, when a number of sheets contained in a recording medium tray in a large image forming apparatus increases, a very large force is needed to manipulate the recording medium tray so that the manipulability is further deteriorated. Furthermore, when the recording medium tray is loaded in the large image forming apparatus, the recording medium tray needs to be firmly supported in the image forming apparatus. However, when the recording medium tray is driven by a drive unit, supporting the recording medium tray at an accommodation complete position and configuring the recording medium tray to be disassembled from the image forming apparatus is not possible.

### SUMMARY OF THE INVENTION

The present general inventive concept provides a recording medium tray assembly/disassembly mechanism to improve manipulation in an accommodation and ejection of a recording medium tray, and an image forming apparatus to employ the recording medium tray assembly/disassembly mechanism.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a recording medium tray assembly/disassembly mechanism in an image forming apparatus, the recording medium tray assembly/disassembly mechanism including a sensor to detect an accommodation operation or an ejection operation of the recording medium tray, and a drive mechanism to connect to the recording medium tray based on a detection by the sensor and to accommodate the recording medium tray at an accommodation complete position or to eject the recording medium tray from the accommodation complete position.

Since the recording medium tray can be disassembled from the image forming apparatus, the accommodation operation or ejection operation of the recording medium tray with respect to the image forming apparatus may be detected by the sensor. The drive mechanism may be connected to the recording medium tray so that the recording medium tray is accommodated at an accommodation complete position and the recording medium tray is ejected from the accommodation complete position, based on the detection by the sensor. Thus, the recording medium tray is automatically accommodated or ejected and simultaneously the recording medium tray is disassembled from the image forming apparatus so that the manipulation can be greatly improved.

The recording medium tray drive mechanism may include a motor and a second connection portion driven by receiving a drive force of the motor and transferring the drive force of the motor to a first connection portion provided at the recording medium tray. According to the above structure, since the drive force of the motor is transferred from the second connection portion to the first connection portion of the recording medium tray, the recording medium tray can be driven by the drive force of the motor.

The recording medium tray drive mechanism may include a first elastic member to elastically press the recording medium tray in an accommodation direction at the accommodation complete position. According to the above structure, since the recording medium tray is elastically pressed in an accommodation direction at the accommodation complete position, the recording medium tray can be firmly supported.

When the ejection operation is performed at the accommodation complete position, as the first elastic member is displaced, the recording medium tray may be moved in an ejection direction, and the ejection operation may be detected by the sensor. According to the above structure, when the ejection operation is performed at the accommodation complete position, since the first elastic member is displaced, the recording medium tray is moved in an ejection direction so that the ejection operation can be detected by the sensor.

The recording medium tray drive mechanism may include a second elastic member that may be displaced when a manipulation force by the accommodation operation is applied to the drive mechanism. According to the above structure, during the accommodation of the recording medium tray, when the manipulation force of the accommodation operation is applied to the drive mechanism, since the second elastic member is displaced, even when an excess manipulation force by the accommodation operation is applied, the force applied to the drive mechanism can be absorbed by the second elastic member. Thus, the drive mechanism can be prevented from being damaged.

When the accommodation operation is performed, as the second elastic member may be displaced, the recording medium tray may be moved in the accommodation direction, and the accommodation operation may be detected by the sensor. According to the above structure, when the accommodation operation is performed, as the second elastic member is displaced, the recording medium tray is moved in the accommodation direction and the accommodation operation can be detected by the sensor.

The recording medium tray assembly/disassembly mechanism may further include a plurality of members to transfer the drive force of the motor to the second connection portion, wherein the first and second elastic members may be provided in a portion where the members relatively move. According to the above structure, since the first and second elastic members are provided in a portion where the member to transfer the drive force of the motor to the second connection portion are relatively moved, the recording medium tray can be firmly supported by the first elastic member at the accommodation complete position. Also, when the manipulation force in a direction in which the recording medium tray is accommodated is applied to the drive mechanism, the force can be absorbed by the second elastic member.

The recording medium tray assembly/disassembly mechanism may further include a support portion to elastically expand with movement of the recording medium tray at around the accommodation complete position, wherein the recording medium tray may be supported in the image forming apparatus by the support portion at the accommodation complete position. According to the above structure, the recording medium tray can be firmly supported by the elastic deformation of the support at the accommodation complete position.

The sensor may when the recording medium tray arrives approximately at the accommodation complete position during the accommodation of the recording medium tray and the driving of the motor may be stopped by the detection. According to the above structure, the recording medium tray can be automatically accommodated by the elasticity of the support portion by detecting that the recording medium tray arrives at around the accommodation complete position and stopping the driving of the motor.

The driving of the motor may be stopped when the sensor detects that the recording medium tray arrives at a position where a connection between the second connection portion and the first connection portion is removed during the ejection of the recording medium tray. According to the above structure, after the driving of the motor is stopped, the recording medium tray can be disassembled from the image forming apparatus.

After the driving of the motor is stopped, the motor may rotate in a direction opposite to a motor ejection direction for a predetermined time. According to the above structure, after the driving of the motor is stopped, the drive mechanism can be set to the initial state.

The recording medium tray assembly/disassembly mechanism may further include at least two members to transfer the drive force of the motor to the second connection portion, wherein the two members function as a friction clutch. According to the above structure, even when an excess manipulation force is applied during the accommodation operation or ejection operation, since a friction clutch is operated, the drive mechanism can be prevented from being damaged.

The foregoing and/or other aspects and utilities of the general inventive concept may also be achieved by providing an image forming apparatus include the above recording medium tray assembly/disassembly mechanism and a printing portion printing an image on a sheet of recording medium supplied from the recording medium tray. According to the above structure, since the recording medium tray is automatically accommodated and ejected and simultaneously the recording medium tray can be disassembled from the image forming apparatus, the manipulation of the image forming apparatus is greatly improved.

### BRIEF DESCRIPTION OF THE DRAWINGS

The above and other features and utilities of the present general inventive concept will become more apparent by describing in detail embodiments thereof with reference to the attached drawings in which:

FIG. 1 illustrates an overall structure of an image forming apparatus according to an embodiment of the present general inventive concept;

FIG. 2 illustrates a structure of a recording medium tray assembly/disassembly mechanism of a recording medium tray, according to an embodiment of the present general inventive concept;

FIG. 3 illustrates a detailed structure of a drive mechanism, viewed in a direction indicated by an arrow A of FIG. 2, according to an embodiment of the present general inventive concept;

FIG. 4 illustrates angular positions of a drive gear, a disc B, and a torsion spring of the drive mechanism of FIG. 3;

FIG. 5 illustrates an operation of an accommodation method when a recording medium tray is loaded in an image forming apparatus, according to an embodiment of the present general inventive concept;

FIG. 6 is a timing chart illustrating changes of an output of sensors during the accommodation of the recording medium tray in the image forming apparatus, according to an embodiment of the present general inventive concept;

FIG. 7 illustrates an ejection method when the recording medium tray is ejected from the image forming apparatus, according to an embodiment of the present general inventive concept;

FIG. 8 is a timing chart illustrating changes of the output of the sensors during an ejection of the recording medium tray, according to an embodiment of the present general inventive concept;

FIG. 9 illustrates a drive mechanism of the recording medium tray, according to another embodiment of the present general inventive concept;

FIG. 10 illustrates an accommodation method according to another embodiment of the present general inventive concept;

FIG. 11 is a timing chart illustrating changes of the output of sensors during the accommodation of the recording medium tray, according to another embodiment of the present general inventive concept;

FIG. 12 illustrates an ejection method when the recording medium tray is ejected from the image forming apparatus, according to another embodiment of the present general inventive concept;

FIG. 13 is a timing chart illustrating changes of the output of sensors during the ejection of the recording medium tray, according to another embodiment of the present general inventive concept;

FIG. 14 illustrates a structure of a recording medium tray assembly/disassembly mechanism provided in an image forming apparatus, according to an embodiment of the present general inventive concept;

FIG. 15 illustrates a detailed structure of the drive mechanism, viewed as indicated by an arrow A of FIG. 14, according to an embodiment of the present general inventive concept;

FIG. 16 illustrates an accommodation method of the recording medium tray, according to an embodiment of the present general inventive concept;

FIG. 17 is a timing chart illustrating that the output of a sensor during the accommodation of the recording medium tray, according to another embodiment of the present general inventive concept;

FIG. 18 is a graph illustrating a relation of the insertion force and the position of the recording medium tray during the accommodation of the recording medium tray, according to an embodiment of the present general inventive concept;

FIG. 19 sequentially illustrates an ejection method of the recording medium tray, according to an embodiment of the present general inventive concept;

FIG. 20 is a timing chart illustrating that the output of a sensor during the ejection of the recording medium tray, according to another embodiment of the present general inventive concept;

FIG. 21 is a graph illustrating a relation between the ejection force and the position of the recording medium tray during the ejection of the recording medium tray, according to an embodiment of the present general inventive concept;

FIG. 22 is a schematic diagram of a recording medium tray being loaded into/ejected from an image forming apparatus;

FIG. 23 is a diagram sequentially illustrating that a catch, provided in the image forming apparatus, is coupled to the coupling portion of the recording medium tray;

FIG. 24 is a graph illustrating changes of an insertion force for inserting the recording medium tray according to the elasticity of the catch;

FIG. 25 is a graph illustrating the changes of an ejection force for inserting the recording medium tray according to the elasticity of the catch; and

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

### First Embodiment

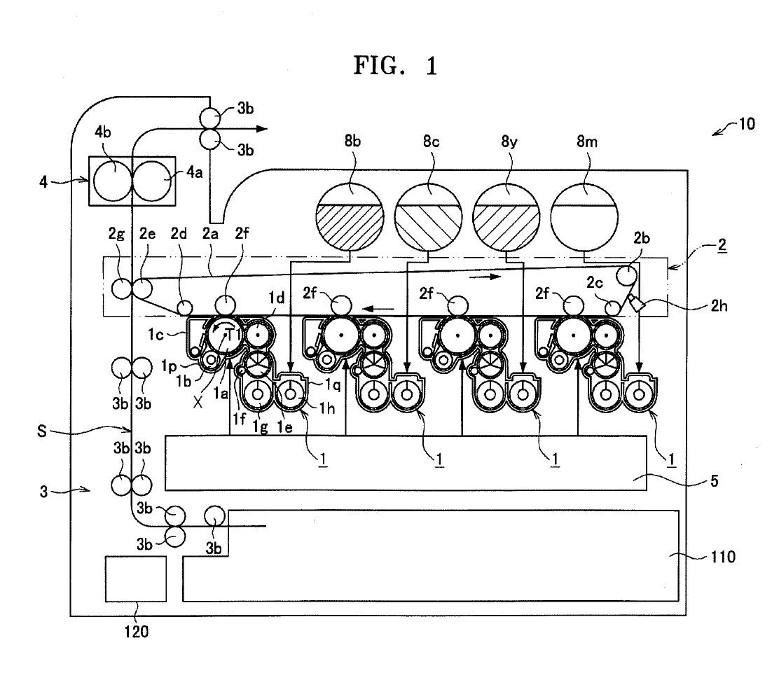

FIG. 1 illustrates an overall structure of an image forming apparatus 10 according to an embodiment of the present general inventive concept. Referring FIG. 1, the overall structure of the image forming apparatus 10, according to the present embodiment of the present general inventive concept is described below. The image forming apparatus 10 can be of an electrophotographic type such as a copier, a printer, and a facsimile apparatus. The image forming apparatus 10 forms an image using a developer that is a mixture of, for example, a non-magnetic toner and a magnetic carrier.

The image forming apparatus 10, is of a tandem type, and includes a print portion to print an image on a recording medium S according to an image signal. The print portion includes a plurality of developing units 1 provided for each color of magenta, yellow, cyan, and black according to an image signal of an image to be recorded and forming a toner image of each color, an intermediate transfer body 2 having a transfer belt 2a on which the toner image formed by each of the developing units 1 is sequentially transferred, a recording medium transfer unit 3 to extract the recording medium S from a recording medium tray 110, in which the recording medium S, such as a sheet of paper, is initially contained, and transferring the recording medium S, and a fusing apparatus 4 to fix the toner image transferred from the intermediate transfer body 2 to the recording medium S on the recording medium S.

As illustrated in FIG. 1, each of the developing units 1 includes a photosensitive drum (image holding unit) 1a, a charger 1b, a cleaning apparatus 1c, a toner holding unit 1d, a developer holding unit 1e, a restriction member 1f, and a pair of toner developer agitation units 1g and 1h. The photosensitive drum 1a is an almost cylindrical member and rotatably disposed around an axis X. The charger 1b charges an outer circumferential surface of the photosensitive drum 1a uniformly with negative charges. The cleaning apparatus 1c is disposed at the left of the photosensitive drum 1a and removes toner adhering to the outer circumferential surface of the photosensitive drum 1a. The toner holding unit 1d supplies toner having negative charges to an electrostatic latent image formed on the outer circumferential surface of the photosensitive drum 1a by a light scanning apparatus 5, to form a toner image on the photosensitive drum 1a. The developer holding unit 1e including a fixed magnet body magnetically holds the developer, which is a mixture of the toner and the magnetic carrier, on the outer circumferential surface of the developer holding unit 1e and transfers the toner to supply the toner to the toner holding unit 1d. The restriction member 1f restricts an amount of the developer held by the developer holding unit 1e and forms a developer thin layer. The toner developer agitation units 1g and 1h agitate the developer and transfer the agitated developer to the developer holding unit 1e.

Also, the light scanning apparatus 5 is provided in the image forming apparatus 10 separately from the developing units 1. The light scanning apparatus 5 emits a laser beam onto the outer circumferential surface of the photosensitive drum 1a charged to a uniform electric potential to be exposed to the laser beam so that an electrostatic latent image is formed on the photosensitive drum 1a according to an image signal of an image to be recorded.

The developer holding unit 1e, the restriction member 1f, and the toner developer agitation units 1g and 1h are integrally provided in a second case (accommodation portion) 1q. The toner developer agitation units 1g and 1h are arranged under the developer holder unit 1e. The developer, which is a mixture of the toner and the carrier, is accommodated in a lower portion of the second case 1q where the toner developer agitation units 1g and 1h are arranged. In addition, apart from the developing units 1, toner containers 8m, 8y, 8c, and 8b containing toner of the respective colors of magenta, yellow, cyan, and black are disposed in the image forming apparatus 10. The toner containers 8m, 8y, 8c, and 8b are respectively connected to the second case 1q of the developing units 1 and supply the toner.

The intermediate transfer body 2 includes the endless type transfer belt 2a, a plurality of first transfer rollers 2f corresponding to the developing units 1, a second transfer roller 2g, and a belt cleaning apparatus 2h. The transfer belt 2a is circulated by a drive roller 2b, a tension roller 2c, and support rollers 2d and 2e. The first transfer rollers 2f are disposed corresponding to the developing units 1 at an inside of the transfer belt 2a and press the transfer belt 2a to contact the outer circumferential surface of the photosensitive drum 1a of the developing units 1. The second transfer roller 2g is disposed at a downstream end of a transfer direction (arrow direction) of the transfer belt 2a to face the support roller 2e arranged at the downstream end further than the developing unit 1 to develop a black toner image. The transfer belt 2a is located between the second transfer roller 2g and the support roller 2e. The belt cleaning apparatus 2h is disposed at the very upstream end of the transfer direction of the transfer belt 2a, such that the belt cleaning apparatus 2h is located at the upstream end further than the developing unit 1 to form a magenta toner image, and to remove the toner adhering to the outer circumferential surface of the transfer belt 2a.

The recording medium transfer unit 3 includes a plurality of transfer rollers 3b rotated in synchronism and extracts the recording medium S from the recording medium tray 110 to supply the recording medium S between the second transfer roller 2g and the transfer belt 2a. Also, the recording medium transfer unit 3 transfers the recording medium S holding the toner image by the second transfer roller 2g to the fusing apparatus 4 disposed at the downstream end of the transfer direction of the recording medium S so that the recording medium S on which the toner image is melt and fixed is further transferred to be ejected from the main body of the image forming apparatus 10.

The fusing apparatus 4 includes a heating roller 4a and a press roller 4b, which have outer circumferential surfaces contacting each other at a predetermined pressure. The heating roller 4a is formed by, for example, providing a heat-resistant elastic layer such as silicon rubber on an outer circumferential surface of a metal core member that is almost cylindrical. A heat source, such as a halogen ramp, is provided in an inside of the heating roller 4a. The press roller 4b is formed by, for example, providing a heat-resistant elastic layer such as silicon rubber on the outer circumferential surface of a metal core member that is almost cylindrical. The fusing apparatus 4 heats, melts, and presses the toner image held by the recording medium S as the recording medium S is supplied between the heating roller 4a and the press roller 4b to melt and fuse the toner image onto the recording medium S.

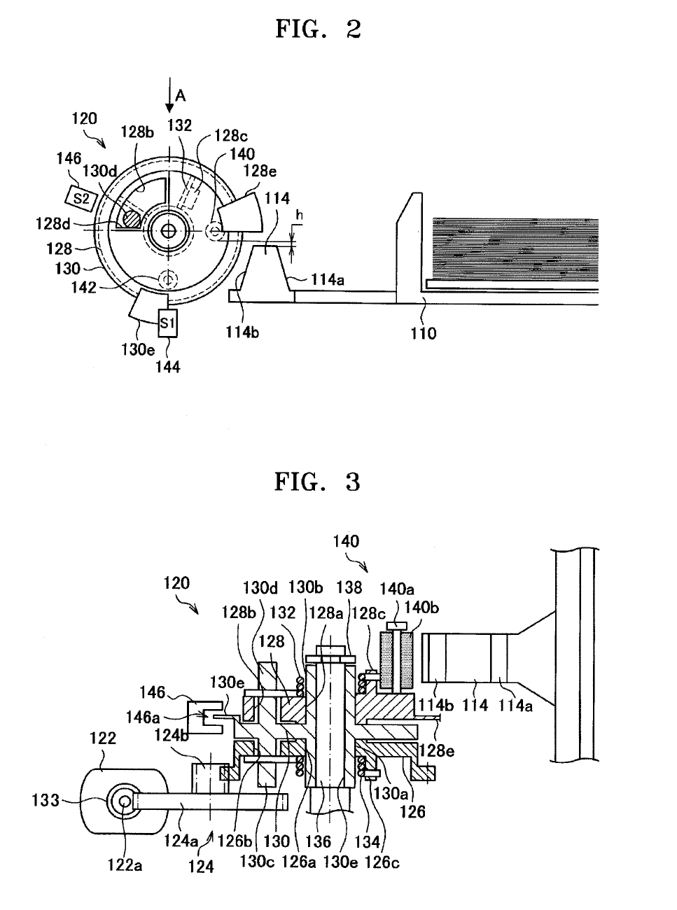

FIG. 2 illustrates a structure of a recording medium tray assembly/disassembly mechanism of a recording medium tray 110, according to an embodiment of the present general inventive concept. FIG. 2 also illustrates the recording medium tray assembly/disassembly mechanism viewed from a side of the recording medium tray 110, that is, in a direction perpendicular to a direction in which the recording medium tray 110 moves. As illustrated in FIG. 2, a hook (first connection portion) 114, protruding like a mountain shape is disposed at a rear portion of the recording medium tray 110. As illustrated in FIG. 2, the hook 114 has a width that decreases toward a top end of the hook 114 and also includes two inclined surfaces 114a and 114b.

A drive mechanism 120 is disposed in the main body of the image forming apparatus 10 to drive the recording medium tray 110. FIG. 3 illustrates a detailed structure of the drive mechanism 120, viewed in a direction indicated by an arrow A of FIG. 2, according to an embodiment of the present general inventive concept. As illustrated in FIG. 3, the drive mechanism 120 includes a motor 122, a deceleration gear 124, a drive gear 126, a disk A 128, and a disk B 130, a torsion spring A (first elastic member) 132, and a torsion spring B (second elastic member) 134. A power transfer apparatus 133 is disposed at a drive shaft 122a of the motor 122. Also, the deceleration gear 124 has two gears 124a and 124b, which have different pitch circle diameters and are integrally formed. The power transfer apparatus 133 is engaged with the gear 124a having a relatively larger diameter of the two gears 124a and 124b of the deceleration gear 124.

The gear 124b having a relatively smaller diameter is engaged with the drive gear 126. A hole 126a is formed at a rotation center of the drive gear 126, in which a shaft 130a provided at the disk B 130 is inserted. The drive gear 126 is capable of rotating with respect to the disk B 130. Also, a hole 128a is formed at the rotation center of the disk A 128, in which a shaft 130b of the disk B 130 is inserted. Thus, the disk A 128 is capable of rotating with respect to the disk B 130.

A fan-shaped hole 126b is provided in the drive gear 126. Also, a fan-shaped hole 128b is provided in the disk A 128. A boss 130c, provided on the disk B 130 and protruding toward the drive gear 126, passes through the fan-shaped hole 126b of the drive gear 126. A boss 130d, provided on the disk B 130 and protruding toward the disk A 128, passes through the fan-shaped hole 128b of the disk A 128.

The rotation center of the disk B 130 is the same as the shafts 130a and 130b, and a hole 130e is formed at the rotation center, in which the shaft 136 is inserted. The shaft 136 is fixed to the main body of the image forming apparatus 10. A C-ring 138 is disposed at an end of the shaft 136 and restricts the movement in the axial direction of the disk B 130.

In FIG. 2, a positional relationship among the disk A 128, the disk B 130, and the torsion spring A 132 of the drive mechanism 120 are illustrated. As illustrated in FIG. 2, two rollers (second connection portions) 140 and 142 are disposed on the disk A 128 by being opposite from each other by 90° with respect to the rotation center. As illustrated in FIG. 3, the roller 140 includes a roller shaft 140a fixed to the disk A 128 and a roller rubber 140b inserted around the roller shaft 140a. Likewise, the roller 142 includes a roller shaft 142a fixed to the disk A 128 and a roller rubber 142b inserted around the roller shaft 142a.

As illustrated in FIG. 3, a position of the hook 114 corresponds to positions of the rollers 140 and 142 in terms of a positional relation in a horizontal direction. A width of the hook 114 corresponds to lengths of the rollers 140 and 142.

As illustrated in FIG. 2, the boss 130d of the disk B 130 penetrates the fan-shaped hole 128b of the disk A 128. As illustrated in FIGS. 2 and 3, a protrusion portion 128c is provided on the disk A 128. As illustrated in FIG. 3, a ring portion of the torsion spring A 132 is inserted around the shaft 130b of the disk B 130. Two end portions of the torsion spring A 132 are compressed in directions approaching each other and inserted between the protrusion portion 128c and the boss 130d. Accordingly, the protrusion portion 128c and the boss 130d receive forces in directions opposite from each other by the elastic force of the torsion spring A 132 so that, as illustrated in FIG. 2, the boss 130d contacts a side surface 128d of the fan-shaped hole 128b.

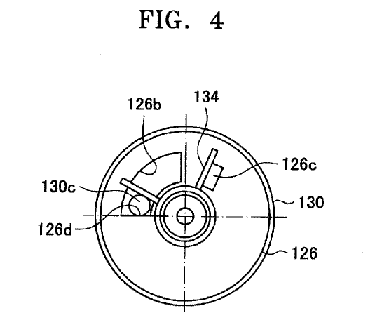

FIG. 4 illustrates angular positions of the drive gear 126, the disc B 130, and the torsion spring B 134 of the drive mechanism 120. FIG. 4 also illustrates the positional relationship when the drive mechanism 120 is viewed in the same direction as in FIG. 2. For convenience of explanation, in FIG. 4, other members are omitted in the description.

As illustrated in FIG. 2, the boss 130c of the disk B 130 penetrates the fan-shaped hole 126b of the drive gear 126. Also, as illustrated in FIGS. 2 and 4, a protrusion portion 126c is provided at the drive gear 126. As illustrated in FIG. 3, a ring portion of the torsion spring B 134 is inserted around the shaft 130a of the disk B 130. Two end portions of the torsion spring B 134 are compressed in directions approaching each other and inserted between the protrusion portion 126c and the boss 130c. Accordingly, the protrusion portion 126c and the boss 130c receive forces in directions opposite from each other by the elastic force of the torsion spring B 134 so that the boss 130c contacts a side surface 126d of the fan-shaped hole 126b.

Also, as illustrated in FIG. 2, a shutter 128e is provided at a predetermined angular position on the outer circumferential surface of the disk A 128. Likewise, a shutter 130e is provided at a predetermined angular position on the outer circumferential surface of the disk B 130. As illustrated in FIG. 3, the shutter 128e and the shutter 130e are arranged on the same plane perpendicular to the rotation center shaft of each of the disks 128 and 130. As illustrated in FIG. 2, two sensors S1 144 and S2 146 are provided outside of the outer circumference of the disk A 128 and the disk B 130 by being separated apart from each other by a predetermined angle with respect to the rotation center.

FIG. 3 illustrates the sensor S2 146 in which a slit 146a (gap) is provided and a light transmission portion and a light receiving portion are arranged to face each other with respect to the slit 146a. The light transmission portion transmits infrared light in a direction perpendicular to a sheet surface of FIG. 2 and the infrared light is received by the light receiving portion. The structure of the sensor 144 is the same as that of the sensor 146.

As illustrated in FIG. 3, the shutters 128e and 130e are positioned to be detected by the sensors 144 and 146. The shutters 128e and 130e are inserted in the slits of the sensors 144 and 146 according to the rotation positions of the disk A 128 and the disk B 130. When the shutters 128e and 130e are inserted in the slits of the sensors 144 and 146, the infrared light from the light transmission portion is blocked by the shutters 128e and 130e. Accordingly, the output of the sensors 144 and 146 are changed from a “low (L)” state to a “high (H)” state. Thus, the angular positions of the disk A 128 and the disk B 130 can be detected by the output of the sensors 144 and 146.

FIGS. 2 and 3 illustrate the positional relationship of the recording medium tray 110 that is not completely installed in the image forming apparatus 10. The angular positions of the drive gear 126, the disk A 128 and the disk B 130 in this state are set to be as initial positions of an initial state. As illustrated in FIG. 2, in the initial state, the roller 142 is located on a linear line passing through the rotation centers of the drive gear 126, the disk A 128, and the disk B 130 while the roller 140 is located on a horizontal line, perpendicular to the linear line passing through the rotation centers of the drive gear 126, passing through the rotation center. In this state, the distance between the upper end of the hook 114 and the roller 140 is “h”.

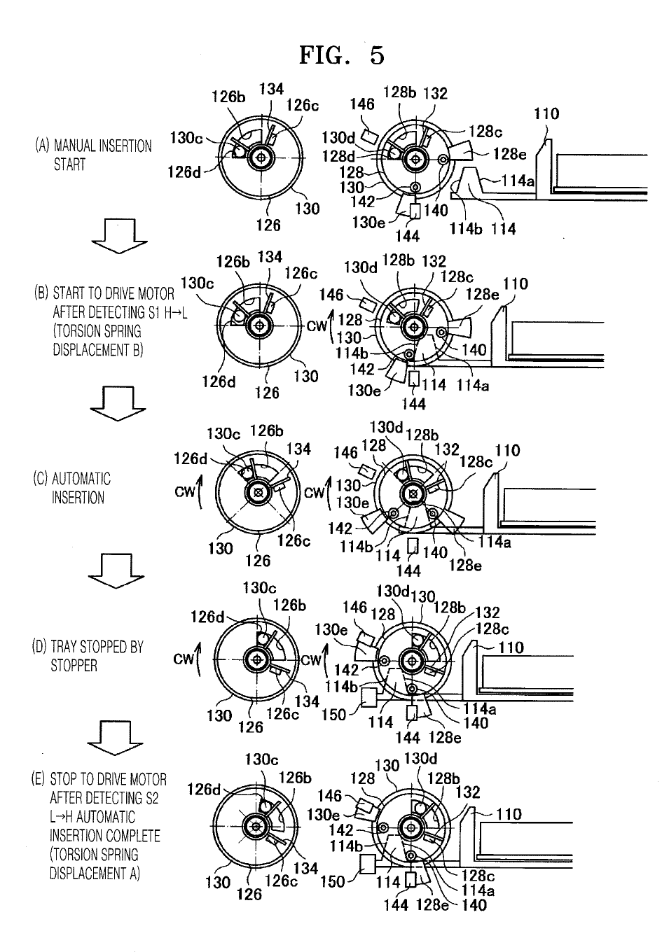

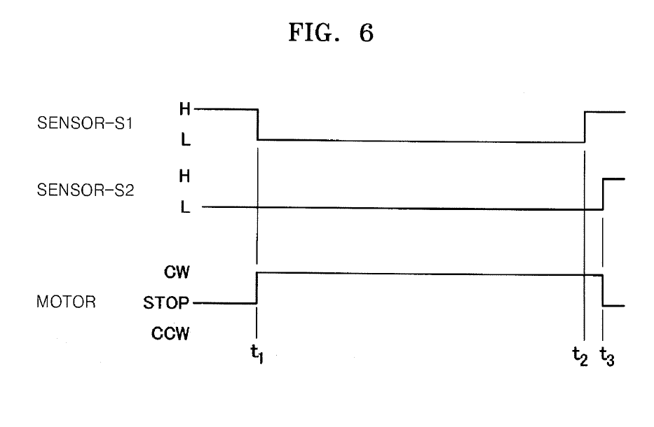

Then, the operation of an accommodation method when the recording medium tray 110 is loaded in the image forming apparatus 10 is described with reference to FIGS. 5 and 6. FIG. 5 illustrates an operation of an accommodation method in which the recording medium tray 110 and the drive mechanism 120 are viewed in a direction perpendicular to a movement direction of the recording medium tray 110 as in FIG. 2. FIG. 6 is a timing chart illustrating changes of an output of the sensors 144 and 146 during the accommodation of the recording medium tray 110 in the image forming apparatus 10, according to an embodiment of the present general inventive concept. The right portion of each of FIGS. 5(A)-5(E) illustrates the positional relationship of the disk A 128, the disk B 130, the torsion spring A 132, and the slits 128e and 130e of the drive mechanism 120 as in FIG. 2. Although in FIG. 2 the members such as the torsion spring A 132, the rollers 140 and 142, the disk A 128, and the protrusion portion 128c are indicated by a dotted line, for convenience of explanation, these members are indicated by a solid line in FIGS. 5(A)-5(E). The left portion of each of FIGS. 5(A)-5(E) illustrates the positional relationship of the drive gear 126, the disk B 130, and the torsion spring B 134 as in FIG. 3.

First, as illustrated in FIG. 5(A), the recording medium tray 110 is manually inserted in the main body of the image forming apparatus 10. The state of FIG. 5(A) corresponds to the initial states of FIGS. 2 and 3 and the angular positions of the drive gear 126, the disk A 128, and the disk B 130 are set to those of the initial state.

Then, as illustrated in FIG. 5(B), when the recording medium tray 110 is inserted, since a gap h is provided between the upper end of the hook 114 and the roller 140, the hook 114 passes under the roller 140 so that the recording medium tray 110 is inserted in the image forming apparatus 10. The inclined surface 114b of the hook 114 contacts the roller 142 and the disk A 128, where the roller 142 is disposed, pivots in a direction CW indicated by an arrow. Since the side surface 128d of the fan-shaped hole 128b of the disk A 128 contacts the boss 130d of the disk B 130, the disk A 128 and the disk B 130 pivot together in the direction CW.

When the disk B 130 pivots, since the boss 130c pivots in the direction CW, an end of the torsion spring B 134 contacting the boss 130c pivots in the direction CW. Since the drive gear 126 is engaged with the power transfer apparatus 133 via the deceleration gear 124, the drive gear 126 cannot pivot. Accordingly, the position of the protrusion portion 126c of the drive gear 126 is not changed and the torsion spring B 134 is compressed due to the pivot of the boss 130c. As illustrated in the left side of the FIG. 5(B), in the state where the drive gear 126 is stopped, the boss 130c pivots in the direction CW in the fan-shaped hole 126b of the drive gear 126.

When the disk B 130 pivots, as illustrated in the right side of the FIG. 5(B), the shutter 130e of the disk B 130 pivots in the direction CW and the shutter 130e exits from the slit of the sensor 144. Accordingly, as illustrated in FIG. 6, the output of the sensors S1 144 is changed from “high (H)” to “low (L)” (at time t1).

When the output of the sensor 144 is in the state of “low (L)”, the motor 122 starts to drive so that the drive gear 126 pivots in the direction CW. When the drive gear 126 pivots, the side surface 126d of the fan-shaped hole 126b of the drive gear 126 contacts the boss 130c. The pivoting of the drive gear 126 is transferred to the disk B 130 so that the disk B 130 pivots in the direction CW with the drive gear 126. Also, when the disk B 130 pivots, since the torsion spring A 132 is interposed between the boss 130d of the disk B 130 and the protrusion portion 128c of the disk A 128, the pivoting of the disk B 130 is transferred to the protrusion portion 128c. Thus, as illustrated in FIG. 5(C), the disk A 128 pivots in the direction CW.

According to the present embodiment, when the recording medium tray 110 is inserted, the torsion spring B 134 provided in the drive mechanism 120 twists so that the disk B 130 can pivot according to the insertion of the recording medium tray 110. Thus, as movement of the shutter 130e of the disk B 130 is detected, the insertion of the recording medium tray 110 can be detected so that the driving of the motor 122 can be initiated based on the above detection. Also, when the recording medium tray 110 is inserted, since the torsion spring B 134 twists, an excess force on the drive mechanism 120 can be avoided. Thus, damage to the drive mechanism 120 due to the force generated when the recording medium tray 100 is inserted can be surely prevented.

As illustrated in FIG. 5(C), the pivoting of the disk A 128 makes the roller 140 and the inclined surface 114a of the hook 114 contact each other. Also, as the disk A 128 pivots, the hook 114 that is pressed by the roller 140 moves to the left side in the insertion direction, as illustrated in the drawing. Thus, the recording medium tray 110 is automatically inserted in the image forming apparatus 10 by the driving force of the motor 122.

When the recording medium tray 110 is completely inserted in the image forming apparatus 10 and reaches the accommodation complete position, as illustrated in FIG. 5(D), the recording medium tray 110 contacts a stopper 150 disposed at the main body of the image forming apparatus 10. The motor 122 continues driving after the recording medium tray 110 contacts the stopper 150. Furthermore, the shutter 128e of the disk A 128 enters into the slit of the sensor 144 before the shutter 130e enters into the slit of the sensor 146 and thus, the output of the sensor 144 changes to the “high (H)” state to indicate this entrance (at time t2, which is before time t3, as illustrated in FIG. 6).

When the motor 122 further rotates, as in the state illustrated in the left side of the FIG. 5(E), the disk B 130 pivots with the drive gear 126. In contrast, since the recording medium tray 110 contacts the stopper 150, the disk A 128 cannot pivot.

Thus, as illustrated in the right side of FIG. 5(E), when the disk B 130 pivots by the driving force of the motor 122, the boss 130d pivots in the direction CW in the fan-shaped hole 128b of the disk A 128 in the state where the disk A 128 is stopped. Thus, the torsion spring A 132 is twisted.

When the torsion spring A 132 is twisted and the disk B 130 pivots in the direction CW, as illustrated in the right side of FIG. 5(E), the shutter 130e of the disk B 130 enters into the slit of the sensor 146. Accordingly, as illustrated in FIG. 6, the output of the sensor B 146 is changed from the “low (L)” state to the “high (H)” state (time t3). When the output of the sensor 146 is in the state of “high (H)”, the driving of the motor 122 is stopped. Consequently, the accommodation of the recording medium tray 110 is complete.

In the state illustrated in FIG. 5(E), since the torsion spring A 132 is twisted, the disk A 128 is elastically pressed in the direction CW. Thus, the inclined surface 114a of the hook 114 receives a force from the roller 140 in an almost vertical direction with respect to the inclined surface 114a. Thus, the recording medium tray 110 can be firmly supported at the accommodation position.

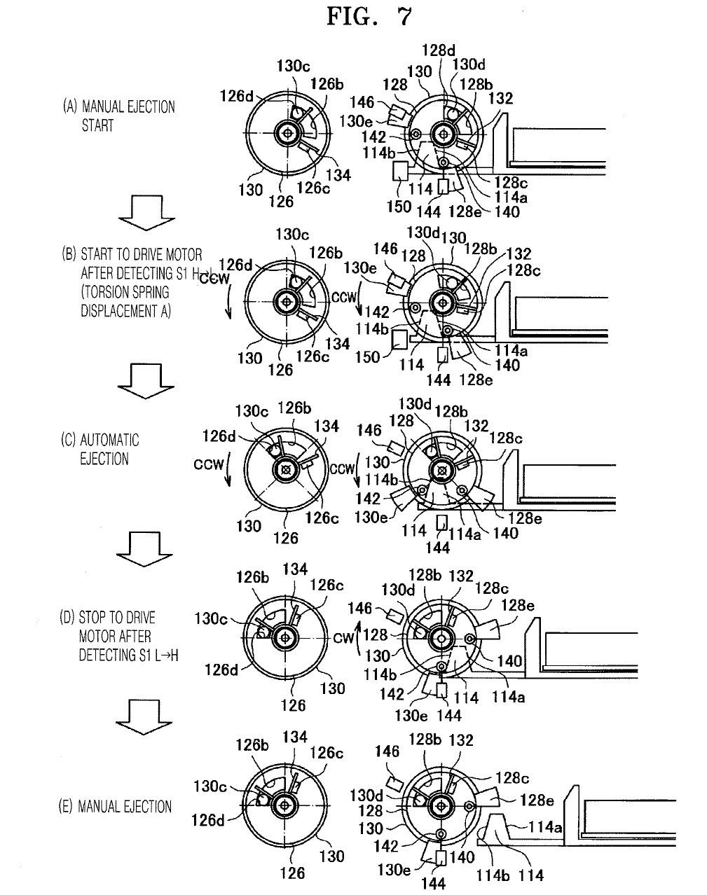

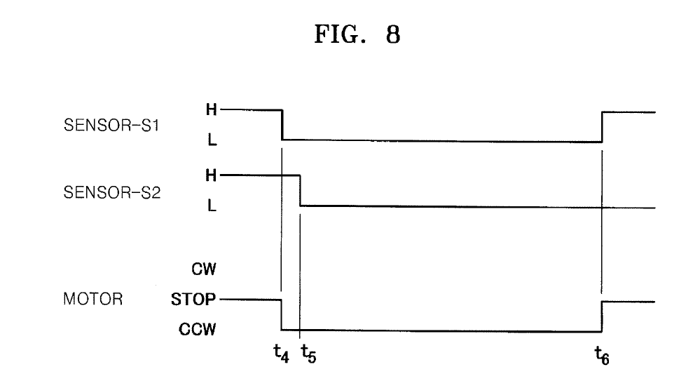

An operation of an ejection method when the recording medium tray 110 is ejected from the image forming apparatus 10 is described below with reference to FIGS. 7 and 8. FIGS. 7(A)-7(E) illustrate the ejection method of the recording medium tray 110 from the image forming apparatus 10. FIG. 8 is a timing chart illustrating changes of the outputs of the sensors 144 and 146 during the ejection of the recording medium tray 110, according to an embodiment of the present general inventive concept.

FIG. 7(A) corresponds to FIG. 5(E), and thus, the recording medium tray 110 is loaded in the image forming apparatus 10. When the recording medium tray 110 is manually ejected from the state as illustrated in FIG. 7(A), the inclined surface 114a of the hook 114 presses the roller 140 to the right direction in the ejection direction so that the disk A 128 pivots in a direction CCW, as illustrated in FIG. 7(B). Since the driving of the motor 122 is stopped, the drive gear 126 cannot pivot by a worm mechanism, such as a worm gear, of the power transfer apparatus 133. Also, since the boss 130c of the disk B 130 contacts the side surface 126d of the fan-shaped hole 126b of the drive gear 126, the disk B 130 cannot pivot in the direction CCW. Thus, when the disk A 128 pivots in the direction CCW, the torsion spring A 132 is twisted between the protrusion portion 128c and the boss 130d according to the movement of the protrusion portion 128c of the disk A 128.

When the disk A 128 pivots in the direction CCW simultaneously with the twisting of the torsion spring A 132, as illustrated in the right side of FIG. 7(B), the shutter 128e of the disk A 128 exits from the slit of the sensor 144. Accordingly, as illustrated in FIG. 8, the output of the sensors S1 144 is changed from the “high (H)” state to the “low (L)” state (at time t4).

When the output of the sensor S1 144 is changed to the “low (L) state”, the driving of the motor 122 is initiated. The motor 122 rotates in the opposite direction to that in the accommodation method. The driving gear 126 pivots in the direction CCW of FIGS. 7(A)-7(E). When the driving gear 126 pivots in the direction CCW, since the torsion spring B 134 is interposed between the protrusion portion 126c of the drive gear 126 and the boss 130c of the disk B 130, the pivoting of the drive gear 126 is transferred to the boss 130c of the disk B 130. Thus, as illustrated in the left side of FIG. 7(C), the disk B 130 pivots in the direction CCW. When the disk B 130 pivots in the direction CCW, the shutter 130e of the disk B 130 exits from the slit of the sensor 146 so that the output of the sensor 146 changes to “low (L)” (at time t5 illustrated in FIG. 8).

According to the structure of the present embodiment, when the recording medium tray 110 is ejected, as the torsion spring A 132 provided in the drive mechanism 120 twists, the disk A 128 can pivot according to the ejection of the recording medium tray 110. Thus, by detecting the movement of the shutter 128e of the disk A 128, whether the recording medium tray 110 is ejected can be detected. Accordingly, the drive of the motor 122 can be initiated based on the detection. Also, when the recording medium tray 110 is ejected, the torsion spring A 132 twists so that an excess force to the drive mechanism 120 can be avoided. Thus, damage to the drive mechanism 120 by the force generated during the ejection of the recording medium tray 110 can be surely prevented.

When the disk B 130 pivots in the direction CCW, the boss 130d of the disk B 130 contacts the side surface 128d of the fan-shaped hole 128b of the disk A 128. Thus, the disk A 128 pivots as illustrated in the right side of FIG. 7(C). As the roller 142 of the disk A 128 contacts the inclined surface 114b of the hook 114 and the inclined surface 114b is pressed, the hook 114 is moved to the right direction in the ejection direction. Thus, the recording medium tray 110 is automatically ejected by the driving force of the motor 122.

As the disk B 130 further pivots, as illustrated in the right side of FIG. 7(D), the shutter 130e of the disk B 130 enters into the slit of the sensor 144. Accordingly, as illustrated in FIG. 8, the output of the sensor S1 144 is changed from the “low (L)” state to the “high (H)” state (at time t6). When the output of the sensor S1 144 is changed to the “high (H)” state, the driving of the motor 122 is stopped.

As illustrated in FIG. 7(D), in the state when the output of the sensor S1 144 is changed to the “high (H)” state, the angular positions of the drive gear 126, the disk A 128, and the disk B 130 are returned to the initial state. Thus, since there is the gap “h” between the upper end of the first connection portion 114 and the roller 140, the recording medium tray 110 can be manually ejected from the image forming apparatus 10. Consequently, the recording medium tray 110 can be ejected out of the image forming apparatus 10. Furthermore, in the present embodiment, one side of each of the torsion springs A 132 and B 134 can be configured as a clutch mechanism.

### Second Embodiment

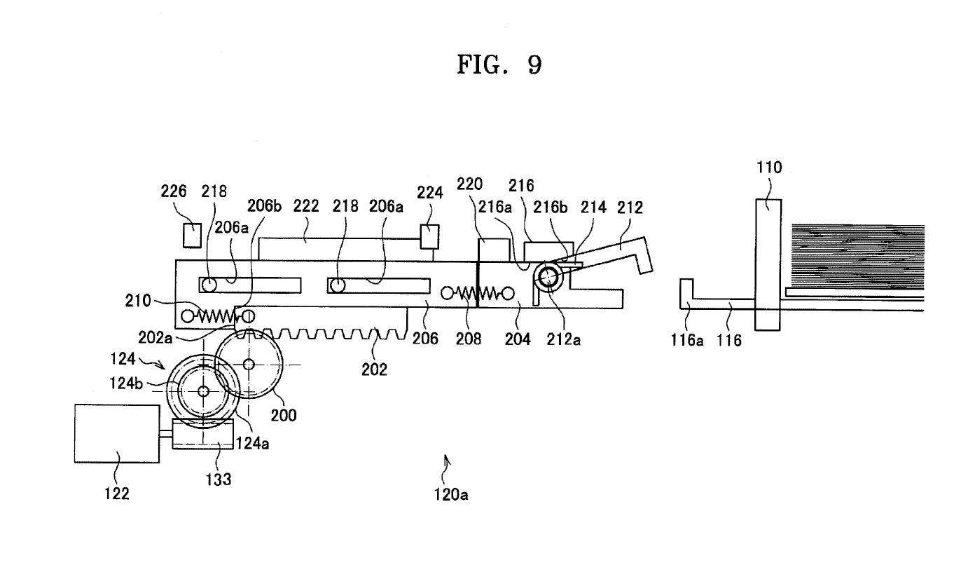

FIG. 9 illustrates a drive mechanism 120a of the recording medium tray 110, according to another embodiment of the present general inventive concept. Referring to FIG. 9, the drive mechanism 120a according to the present embodiment includes the motor 122, the deceleration gear 124, a drive gear 200, a rack 202, a member A 204, a member B 206, an extension coil spring A (first elastic member) 208, an extension coil spring B (second elastic member) 210, a pivot hook 212, a torsion spring 214, and a hook guide 216.

A hook (first connection portion) 116 is disposed at the recording medium tray 110. A position of the hook 116 in a horizontal direction corresponds to the position of the pivot hook 212. An engagement portion 116a to engage the pivot hook (second connection portion) 212 is provided at the hook 116.

In FIG. 9, structures of the motor 122 and the deceleration gear 124 are the same as those in the above embodiment described with reference to FIGS. 2-4. The rotational force of the motor 122 is transferred to the deceleration gear 124 by the power transfer apparatus 133 and decelerated by the deceleration gear 124 to be transferred to the drive gear 200.

The member B 206 includes two slots 206a, and a guide 218 provided at the main body of the image forming apparatus 10 is coupled to the slots 206a so that the guide 218 slides within the slots 296a. Thus, the member B 206 can move to the left and right directions in FIG. 9. Likewise, member A 204 can move to the left and right directions in FIG. 9.

The rack 202 is connected to the member B 206 by the extension coil spring B 210. Also, the member A 204 and the member B 206 are connected by the extension coil spring A 208. The side surface 202a of the rack 202 and the surface 206b of the member B 206 contact each other by the elastic force of the extension coil spring B 210. The sectional surfaces of the member A 204 and the member B 206, facing each other, contact each other by the elastic force of the extension coil spring A 208.

A shutter 220, formed of a thin plate, is provided at the member A 204. Also, a shutter 222, formed of a thin plate, is provided at the member B 206. Two sensors S1 224 and S2 226 are provided around the member A 204 and the member B 206. The sensors S1 224 and S2 226 have the same structures as those of the sensors S1 144 and S2 146 described with reference to FIGS. 2-4. The shutters 220 and 222 are inserted into slits (not illustrated) of the sensors S1 224 and S2 226 according to the movement of the member A 204 and the member B 206, respectively.

The pivot hook 212 is disposed to pivot with respect to the member A 204. The torsion spring 214 has a ring portion that is inserted around a rotation center shaft 212a of the pivot hook 212. Two end portions of the torsion springs 214 are compressed in directions approaching each other such that one of the end portions of the torsion springs 214 is supported by the pivot hook 212 and the other end portion of the torsion springs 214 is supported by the member A 204. Accordingly, the pivot hook 212 receives an elastic force from the torsion spring 214 capable of pivoting counterclockwise in FIG. 9 with respect to the rotation center of the shaft 212a.

The hook guide 216 is fixed to the main body of the image forming apparatus 10, and includes an inclined surface 216b and a contact surface 216a of the pivot hook 212 and has a function to restrict the angle of the pivot hook 212.

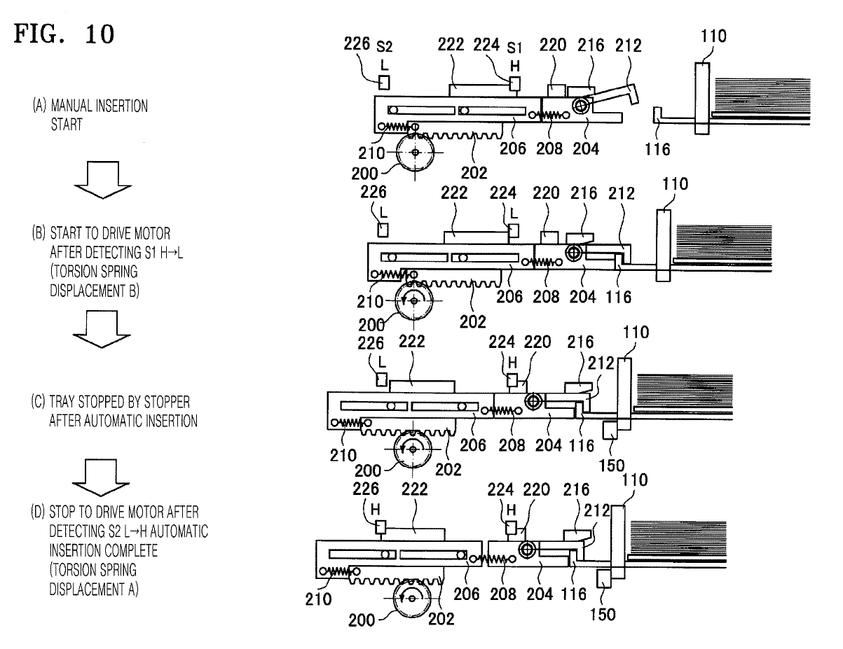

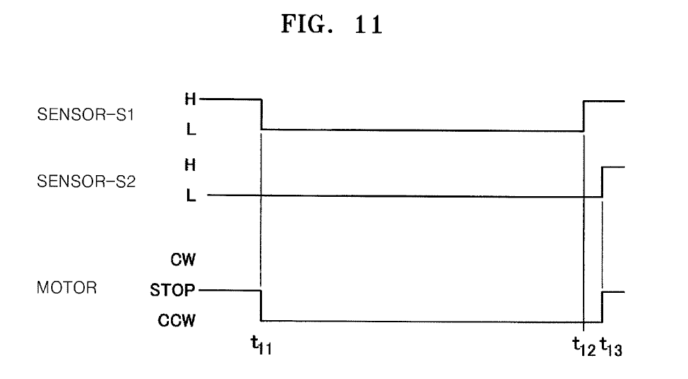

Then, referring to FIGS. 10 and 11, the operation of an accommodation method when the recording medium tray 110 is loaded in the image forming apparatus 10 is described below. FIGS. 10(A)-10(D) illustrate the accommodation method according to another embodiment of the present general inventive concept. FIG. 11 is a timing chart illustrating changes of the outputs of the sensors S1 224 and S2 226 during the accommodation of the recording medium tray 110, according to another embodiment of the present general inventive concept.

First, as illustrated in FIG. 10(A), the recording medium tray 110 is manually inserted in the main body of the image forming apparatus 10. The state of FIG. 10(A) corresponds to the state of FIG. 9. In this state, the shutter 220 is not inserted in the slit of the sensor S1 224 and thus the output of the sensor S1 224 is in the “high (H)” state. Then, as illustrated in FIG. 10(B), as the recording medium tray 110 is further pushed in, the end portion of the hook 116 contacts the member A 204 so that the member A 204 is moved in the left direction.

When the member A 204 is driven in the left direction, the upper surface of the pivot hook 212 receives a force due to restriction of movement of the contact surface 216a of the hook guide 216 so that the pivot hook 212 pivots clockwise around the rotation center shaft 212a. Accordingly, as illustrated in FIG. 10(B), the pivot hook 212 is connected to the engagement portion 116a of the hook 116. Also, since the sectional surfaces of the member A 204 and the member B 206 contact each other, the member B 206 is also moved in the left direction.

However, the rack 202 is engaged with the drive gear 200, and, since the deceleration gear 124, engaged with the drive gear 200, is engaged with the power transfer apparatus 133, the rack 202 does not move. Thus, according to the movement of the member B 206, the extension coil spring B 210 extends so that the member B 206 moves relative to the non-moving rack 202.

As illustrated in FIG. 10(B), when the member A 204 and the member B 206 are moved in the left direction, the shutter 222 exits from the slit of the sensor S1 224. Accordingly, as illustrated in FIG. 11, the output of the sensor S1 224 is changed from the “high (H)” state to the “low (L)” state (at time t11). When the output of the sensor S1 224 is changed from the “high (H)” state to the “low (L)” state, the driving of motor 122 is initiated and the drive gear 200 pivots in the direction CCW of FIG. 10(B). Thus, the rack 202 is driven in the left direction.

When the rack 202 is driven, the side surface 202a of the rack 202 contacts the surface 206b of the member B 206 so that the member B 206 is moved in the left direction. Since the member B 206 and the member A 204 are connected by the extension coil spring A 208, the driving force is transferred to the member A 204 via the extension coil spring A 208 and the member A 204 is driven in the left direction.

Since the pivot hook 212 is connected to the engagement portion 116a of the hook 116, the member A 204 is moved by the driving force of the motor 122 in the left direction so that the recording medium tray 110 is moved in the left direction. Thus, the recording medium tray 110 can be automatically inserted in the image forming apparatus 10.

Then, as illustrated in FIG. 10(C), when the driving of the motor 122 is continuously performed, the recording medium tray 110 contacts the stopper 150 at the main body of the image forming apparatus 10. Also, the shutter 220 enters into the slit of the sensor S1 224 at the timing earlier than that of when the shutter 222 enters the sensor S2 226, and thus, the output of the sensor S1 224 is changed from “low (L)” to “high (H)” (at time t12 of FIG. 11).

Then, as illustrated in FIG. 10(D), when the driving of the motor 122 is continuously performed, since the member A 204 cannot be moved due to the stopper 150, only the member B 206 is driven so that the extension coil spring A 208 extends and the sectional surfaces of the member A 204 and the member B 206 are separated from each other. Then, the shutter 222 enters into the slit of the sensor 226 and the motor 122 is stopped from driving. Thus, as illustrated in FIG. 11, the output of the sensor S2 226 is changed from the “low (L)” state to the “high (H)” state (at time t13). Thus, the accommodation method is complete.

In the state illustrated in FIG. 10(D), a force, in the left direction, acts on the recording medium tray 110 by the elastic force of the extension coil spring A 208. Thus, the recording medium tray 110 can be firmly supported at the accommodation complete position.

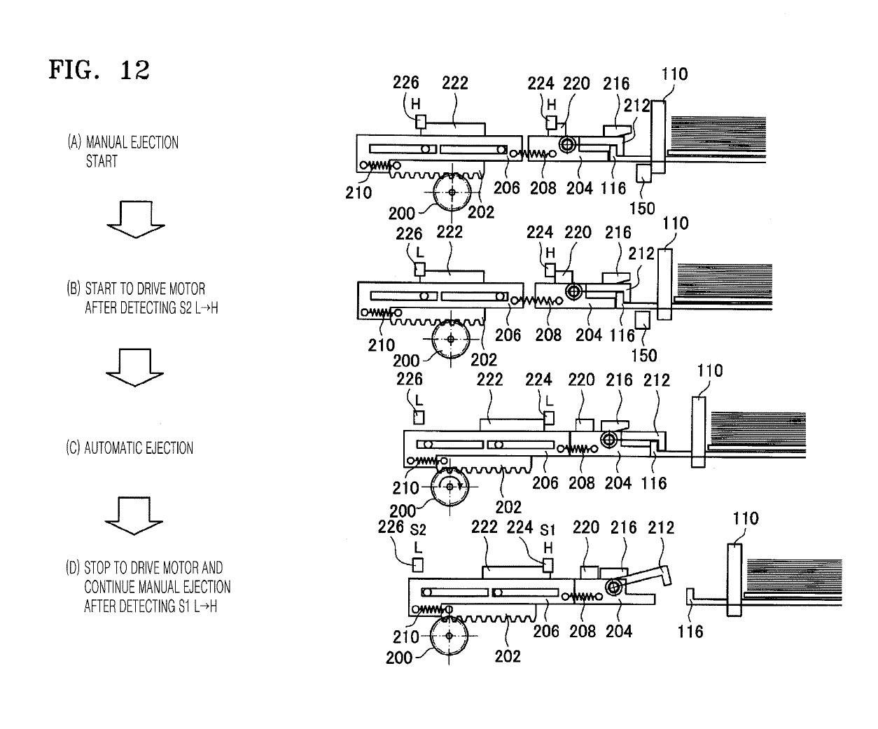

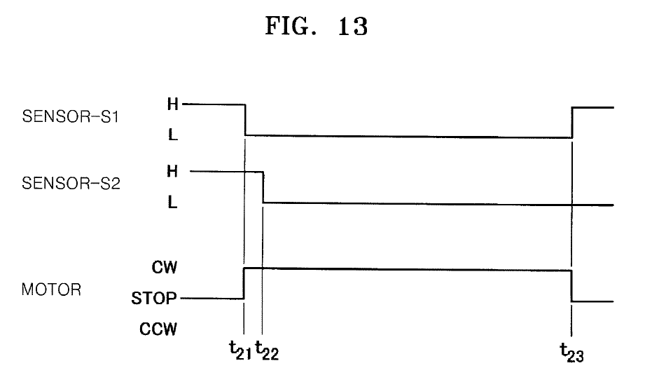

An operation of the ejection method when the recording medium tray 110 is ejected from the image forming apparatus 10 is described below with reference to FIGS. 12 and 13. FIGS. 12(A)-12(D) illustrate the ejection method when the recording medium tray 110 is ejected from the image forming apparatus 10, according to another embodiment of the present general inventive concept. FIG. 13 is a timing chart illustrating changes of the outputs of the sensors S1 224 and S2 226 during the ejection of the recording medium tray 110, according to another embodiment of the present general inventive concept.

FIG. 12(A) corresponds to the state of FIG. 10(D), and thus, the recording medium tray 110 is loaded in the image forming apparatus 10. In FIG. 12(A), when the recording medium tray 110 is manually ejected from the image forming apparatus 10, since the hook 116 is connected to the pivot hook 212, the member A 204 is moved in the right direction. In contrast, since the rack 202 cannot be moved by the worm mechanism, such as a worm gear, of the power transfer apparatus 133 (FIG. 3), the member B 206 cannot be moved in a state in which the surface 206b of the member B 206 contacts the side surface 202a of the rack 202. Thus, the extension coil spring A 208 extends as the recording medium tray 110 is manually ejected from the image forming apparatus 10.

Then, as illustrated in FIG. 12(B), the shutter 220 exits from the slit of the sensor S1 224 due to movement of the member A 204. Accordingly, as illustrated in FIG. 13, the output of the sensor S1 224 is changed from the state “high (H)” to the state “low (L)” (at time t21). Thus, the driving of the motor 122 is initiated so that the drive gear 200 pivots in a direction CW.

When the drive gear 200 pivots in the direction CW, the rack 202 is driven in a right direction. Since the rack 202 and the member B 206 are connected by the extension coil spring B 210, the member B 206 is driven in the right direction. As illustrated in FIG. 12(C), since the sectional surfaces of the member A 204 and the member B 206 contact each other, the member A 204 is driven in the right direction. Accordingly, since end portions of the member A 204 and the hook 116 contact each other, the recording medium tray 110 is driven in the right direction so that the recording medium tray 110 can be automatically ejected.

Then, as illustrated in FIG. 12(D), when the shutter 222 enters into the slit of the sensor 224, the output of the sensor S1 224 is changed from the “low (L)” state to the “high (H)” state (at time t23 of FIG. 13). Thus, the driving of the motor 122 is stopped.

The state of FIG. 12(D) corresponds to the state of FIG. 10A. When the member A 204 is driven to the position of the state illustrated in FIG. 12(D), since restriction in angular movement of the pivot hook 212 by the hook guide 216 is removed, the pivot hook 212 pivots counterclockwise by the elastic force of the torsion spring 214 and the connection of the pivot hook 212 and the hook 116 is removed. Thus, the recording medium tray 110 can be manually ejected.

Furthermore, the extension coil spring A208 according to the present embodiment has a same function as that of the torsion spring A 132 according to the above embodiment described with reference to FIGS. 2-4. Since the extension coil spring A 208 extends when the recording medium tray 110 is ejected, the member A 204 is moved according to the ejection of the recording medium tray 110. Thus, by detecting movement of the shutter 220, the ejection of the recording medium tray 110 can be detected.

The extension coil spring B 210 according to the present embodiment has a same function as that of the torsion spring B 134 according to the above embodiment described with reference to FIGS. 2-4. Since the extension coil spring B 210 extends when the recording medium tray 110 is inserted, the member B 206 is moved according to the insertion of the recording medium tray 110. Thus, by detecting movement of the shutter 222, the insertion of the recording medium tray 110 can be detected.

### Third Embodiment

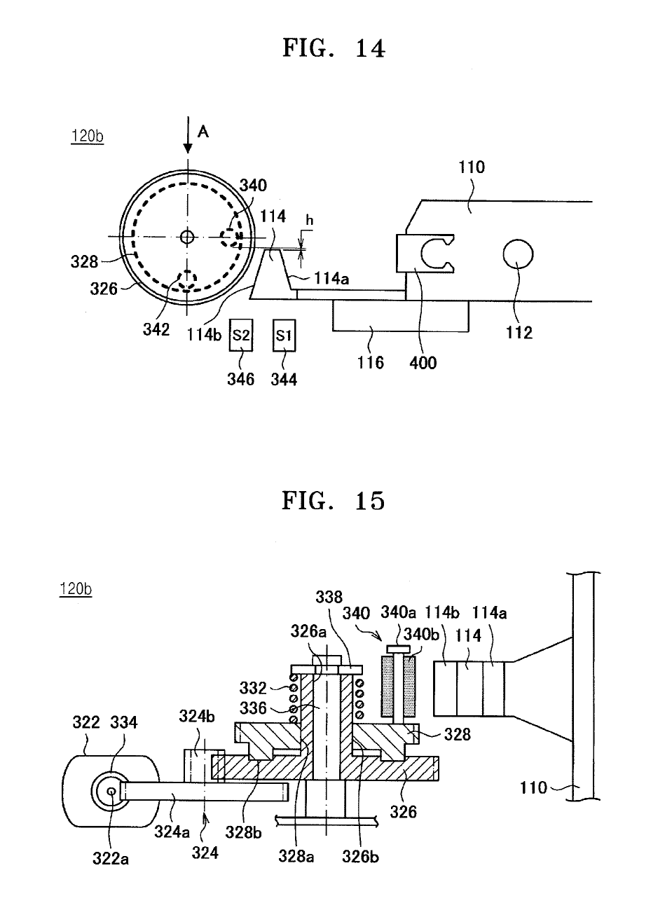

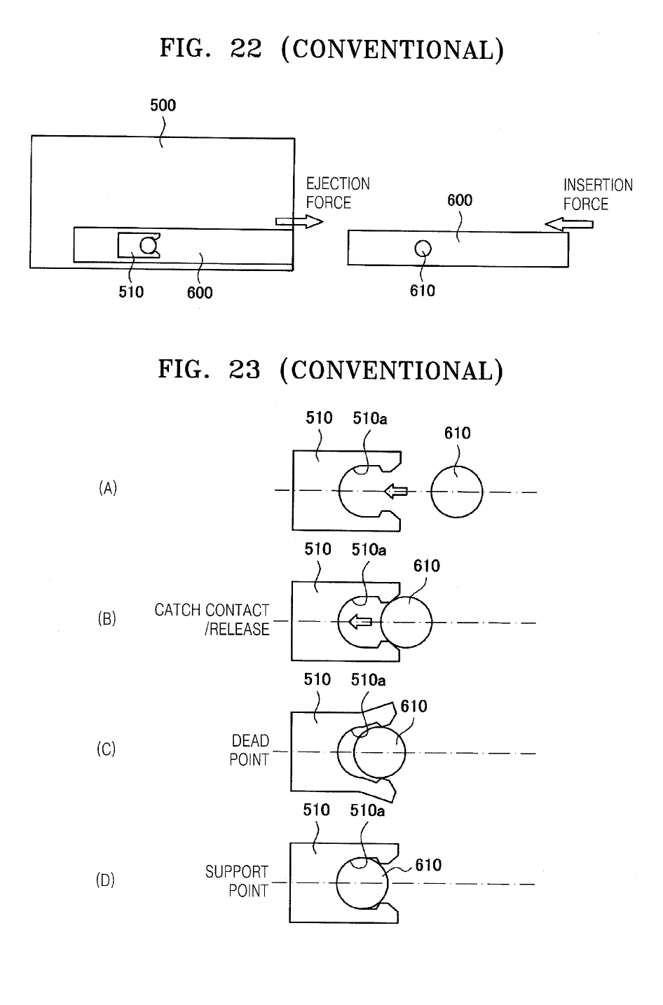

FIG. 14 illustrates a structure of a recording medium tray assembly/disassembly mechanism provided in the image forming apparatus 10, according to an embodiment of the present general inventive concept. FIG. 15 illustrates a detailed structure of a drive mechanism 120b, viewed from a direction perpendicular to the direction in which the recording medium tray 110 moves, according to an embodiment of the present general inventive concept. As illustrated in FIG. 14, an engagement portion 112 is provided at the side of the recording medium tray 110. A catch 400 is provided at the main body of the image forming apparatus 10. The structures of the catch 400 and the engagement portion 112 are the same as those of the ones described in FIGS. 22 and 23.

As illustrated in FIG. 14, the hook 114, protruding in a mountain shape, is disposed at a rear portion of the recording medium tray 110. As illustrated in FIG. 14, the hook 114 has a shape having a width decreasing toward a top portion of the hook 114 and includes two inclined surfaces 114a and 114b.

The drive mechanism 120b is provided at the main body of the image forming apparatus 10 to drive the recording medium tray 110. A gear 326 and a roller disc 328, illustrated in FIG. 14, are part of the drive mechanism 120b. For convenience of explanation, FIG. 14 shows the gear 326, the roller disc 328, and rollers 340 and 342 among members constituting the drive mechanism 120.

FIG. 15 shows the detailed structure of the drive mechanism 120b, viewed as indicated by an arrow A of FIG. 14, according to an embodiment of the present general inventive concept. As illustrated in FIG. 15, the drive mechanism 120b includes a motor 322, a deceleration gear 324, the gear 326, the roller disc 328, and a compression coil spring 332. A power transfer apparatus 334 is disposed around a drive shaft 322a of the motor 322. The deceleration gear 324 includes two gears 324a and 324b which are integrally formed and have different pitch circular diameters. The power transfer apparatus 334 is engaged with the gear 324a having a relatively larger diameter of the gears 324a and 324b of the deceleration gear 324.

The gear 324b having a relatively smaller diameter is engaged with the gear 326. A hole 326a is formed in a rotation center of the gear 326 to insert a shaft 336. The shaft 336 is fixed to the main body of the image forming apparatus 10. A C-ring 338 is disposed at an end portion of the shaft 336 to restrict movement of the gear 326 in a thrust direction. Also, an engagement shaft 326b that is coaxial with the rotational axis of the gear 326 is provided at the gear 326 so that the hole 328a of the roller disc 328 is rotatably disposed with the engagement shaft 326b. The compression coil spring 332 is inserted between surfaces of the C-ring 338 and the roller disc 328 to face each other. The roller disc 328 is pressed against the gear 326 by an elastic force of the compression coil spring 332 and the protruding portion 328b of the roller disk 328 contacts side surface of the gear 326.

Thus, the gear 326 and the roller disc 328 function as a friction clutch so that, when the gear 326 rotates, the drive force of the gear 326 is transferred to the roller disc 328. In a typical operation, the gear 326 and the roller disc 328 are integrally rotated. The elastic force of the compression coil spring 332 is adjusted such that the gear 326 and the roller disc 328 can slip each other and rotate relatively when a relatively great force is applied between the gear 326 and the roller disc 328.

In the drive mechanism 120b configured as above, when the drive shaft 322a of the motor 322 rotates, the rotation of a worm gear of the power transfer apparatus 334 is transferred to the deceleration gear 324, and the rotation of the motor 322 is decelerated by the deceleration gear 324 and transferred to the gear 326. The rotation of the gear 326 is transferred to the roller disc 328 through the friction clutch of the gear 326 and the roller disc 328, and thus, the roller disc 328 is rotated.

As illustrated in FIG. 14, the two rollers (second connection portions) 340 and 342 are disposed at the roller disc 328 to be separated by 90° with respect to the rotation center of the roller disc 328. As illustrated in FIG. 15, the roller 340 includes a roller shaft 340a fixed to the roller disc 328, and a roller rubber 340b inserted around the roller shaft 340a. The roller 342 has a same structure as that of the roller 340.

As illustrated in FIG. 15, a position of the hook 114 corresponds to positions of the rollers 340 and 342 in terms of a positional relation in a horizontal direction. A width of the hook 114 corresponds to lengths of the rollers 340 and 342.

FIG. 14 illustrates an initial state in which the recording medium tray 110 is not installed in the image forming apparatus 10, that is, the engagement portion 112 is not connected to the catch 400. This state is set as the initial state in terms of an angular position of the roller disc 328. As illustrated in FIG. 14, in the initial state, the roller 342 and the roller 340 are respectively located on a vertical line passing through a rotation center of the roller disc 328 and a horizontal line passing through the rotation center of the roller disc 328. In this state, a distance in a vertical direction between the upper end of the hook 114 and the roller 340 is “h”.

As illustrated in FIG. 14, two sensors S1 344 and S2 346 are provided around the roller disc 328. Each of the sensors S1 344 and S2 346 includes a light emitting portion and a light receiving portion which face each other and a slit (pore) interposed therebetween. The light emitting portion emits an infrared light in a direction parallel to a rotation center of the gear 326 such that the infrared light is received by the light receiving portion.

The shutter 116, formed of a thin plate, is provided on a bottom surface of the recording medium tray 110. The position of the shutter 116 corresponds to the positions of the slits of the sensors S1 344 and S2 346. The shutter 116 is inserted in the slits of the sensors S1 344 and S2 346 according to movement of the recording medium tray 110. When the shutter 116 is inserted in the slits of the sensors S1 344 and S2 346, the infrared light emitted from the light emitting portion is blocked by the shutter 116. Accordingly, the outputs of the sensors S1 344 and S2 346 are changed from a “low (L)” state to a “high (H)” state. Thus, the position of the recording medium tray 110 can be detected by the outputs of the sensors S1 344 and S2 346.

As described later, the motor 322 is driven based on the outputs of the sensors S1 344 and S2 346. The outputs of the sensors S1 344 and S2 346 are input to a control portion (not illustrated) and the motor 322 is driven based on a command from the control portion.

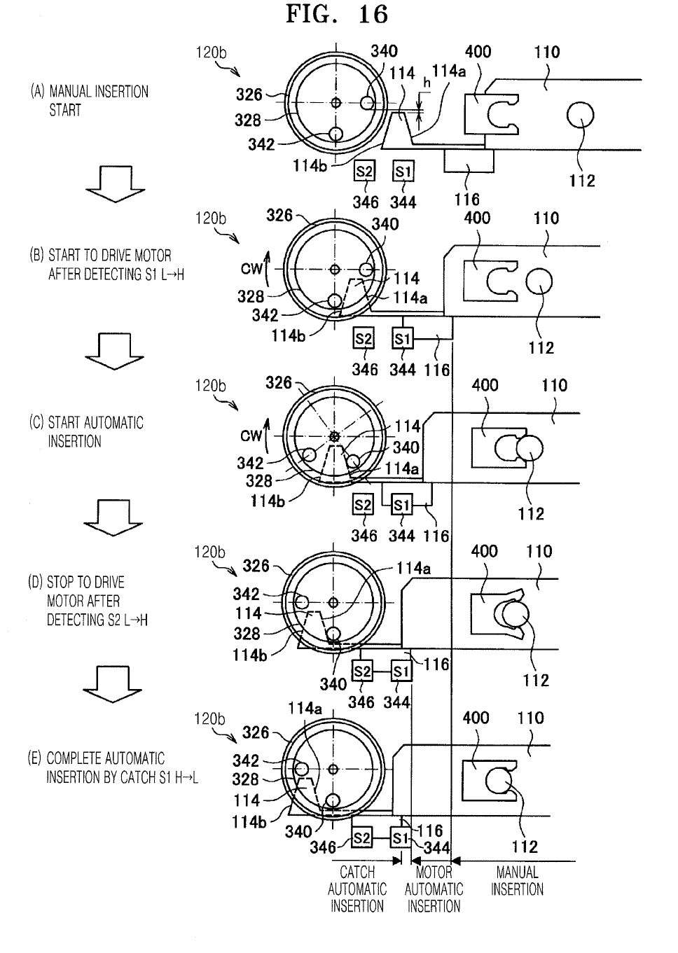

Then, an operation of an accommodation method when the recording medium tray 110 is accommodated in the image forming apparatus 10 will be described with reference to FIGS. 16-18. FIGS. 16(A)-16(E) sequentially illustrate the accommodation method of the recording medium tray 110, according to an embodiment of the present general inventive concept. Like FIG. 14, FIGS. 16(A)-16(E) illustrate the accommodation method of the recording medium tray 110 and the drive mechanism 120b viewed as indicated by an arrow A. FIG. 17 is a timing chart illustrating changes of the outputs of the sensors S1 344 and S2 346 during the accommodation of the recording medium tray 110, according to an embodiment of the present general inventive concept. FIG. 18 is a graph illustrating a relation of an insertion force and the position of the recording medium tray 110 during the accommodation of the recording medium tray 110, according to an embodiment of the present general inventive concept.

As illustrated in FIG. 16(A), the recording medium tray 110 is manually inserted in the main body of the image forming apparatus 10. As illustrated in FIG. 16(A), the shutter 116, at this point, has not been inserted into the slit of the sensor 344, and this initial state is the same as the state of FIG. 14. In the initial state, the angular position of the roller disc 328 is set to the initial state, as illustrated in FIG. 16(A).

Then, as illustrated in FIG. 16(B), when the recording medium tray 110 is further pushed in, since the distance “h” exists between the upper end of the hook 114 and the roller 340, the hook 114 passes under the roller 340 so that the recording medium tray 110 is pushed in the image forming apparatus 10. The shutter 116 is inserted in the slit of the sensor S1 344. Accordingly, as illustrated in FIG. 17, the output of the sensor S1 344 is in the “high (H)” state (at time t1).

When the output of the sensor S1 344 is in the “high (H)” state, the driving of motor 322 is initiated so that the roller disc 328 pivots in a direction indicated by an arrow CW of FIG. 16. As illustrated in FIG. 16(C), when the output of the sensor S1 344 is in the “high (h)” state, the inclined surface 114a of the hook 114 is located under the roller 340. Also, in this state, the engagement portion 112 of the recording medium tray 110 is located at the end of the catch 400. Thus, when the roller disc 328 pivots in the direction CW, the roller 340 contacts the inclined surface 114a of the hook 114 so that the roller disc 328 further pivots. Accordingly, the hook 114 moves in a left direction by movement of the roller 340. Thus, the recording medium tray 110 is automatically pulled into the inside of the image forming apparatus 10 by a drive force of the motor 322.

As illustrated in FIG. 16(D), when the recording medium tray 110 is moved by the drive force of the motor 322, the engagement portion 112 is inserted into an opening of the catch 400. The shutter 116 arrives at the position of the sensor S2 346 and is inserted in the slit of the sensor S2 346. Accordingly, as illustrated in FIG. 17, the sensor S2 346 is changed to the “high (H)” state (at time t2). In this state, the two sensors S1 344 and S2 346 are in the “high (H)” state, and the driving of the motor 322 is stopped at the time t2.

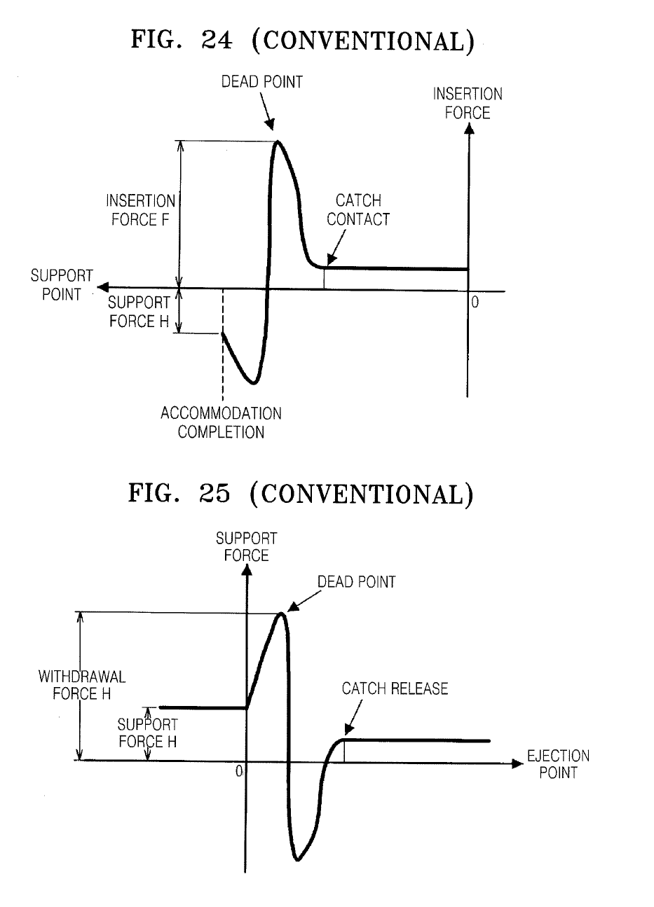

In FIG. 18, the position where the output of the sensor S1 344 turns to the “high (H)” state corresponds to the position of S1 ON. Also, the position where the output of the sensor S2 346 turns to the “high (H)” state corresponds to the position of S2 ON. As it is described for FIGS. 23 and 24, for the manual insertion, the insertion force changes in the method in which the engagement portion 112 is engaged in the catch 400. In the present embodiment, however, as illustrated in FIG. 18, the recording medium tray 110 can be automatically pulled in the main body of the image forming apparatus 10 from S1 ON to S2 ON. Thus, a relatively large force is not necessary when the recording medium tray 110 is pulled in as compared to the method of FIGS. 23 and 24.

When the driving of the motor 322 is stopped at a position illustrated in FIG. 16(D), the engagement portion 112 is pushed in the opening of the catch 400 by a restoration force of the catch 400. Thus, after the driving of the motor 322 is stopped, the recording medium tray 110 is automatically pulled in by the catch 400. When the engagement portion 112 is completely engaged in the opening of the catch 400, the recording medium tray 110 is stopped. In this state, as illustrated in FIG. 16(E), the shutter 116 exits from the slit of the sensor 344. Thus, as illustrated in FIG. 17, the output of the sensor S1 344 is changed from the “high (H)” to the “low (L)” (at time t3).

As illustrated in FIG. 18, in the method of manually inserting the recording medium tray 110, since the engagement portion 112 and the catch 400 are separated from each other initially, the insertion force is a relatively small force F1 mainly opposed by a frictional force. During the period from S1 ON to S2 ON, since the recording medium tray 110 is automatically pulled in by the drive force of the motor 322, the insertion force is not needed. Also, during the period from S2 ON to S1 OFF, since the recording medium tray 110 is automatically pulled in by the restoration force of the of the catch 400, the insertion force is not needed in the period from S2 ON to S1 OFF. Thus, according to the present embodiment, in the section in which the insertion force changes during the method of connecting the engagement portion 112 to the catch 400, the recording medium tray 110 is automatically pulled in so that the recording medium tray 110 can be pulled in and a relatively large force is not needed when the recording medium tray 110 is pulled in. Thus, manipulation of the recording medium tray 110 during the recording medium tray 110 accommodation can be greatly improved.

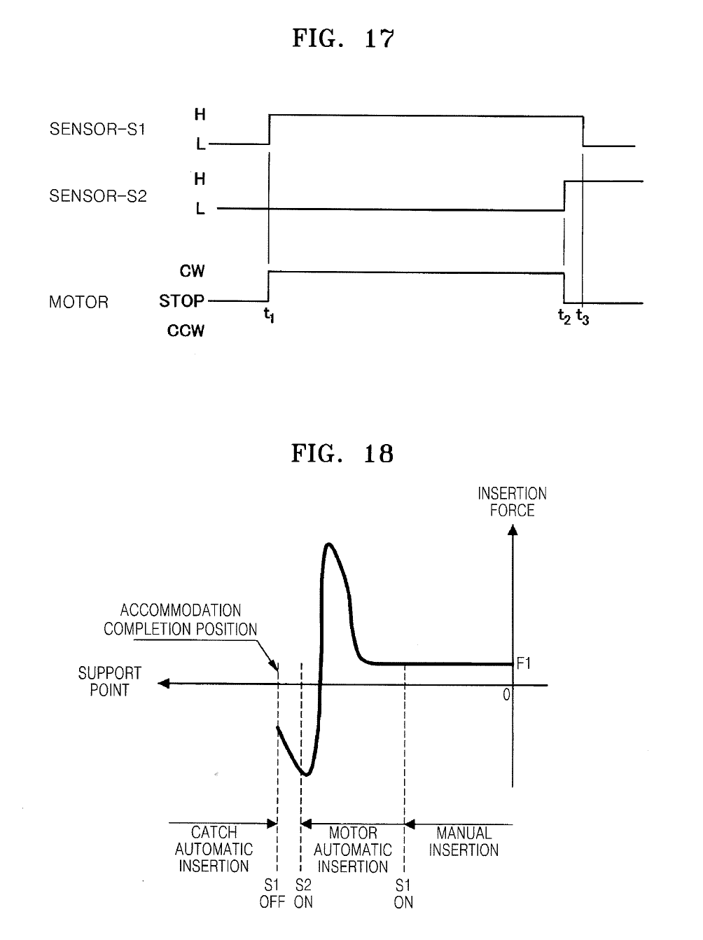

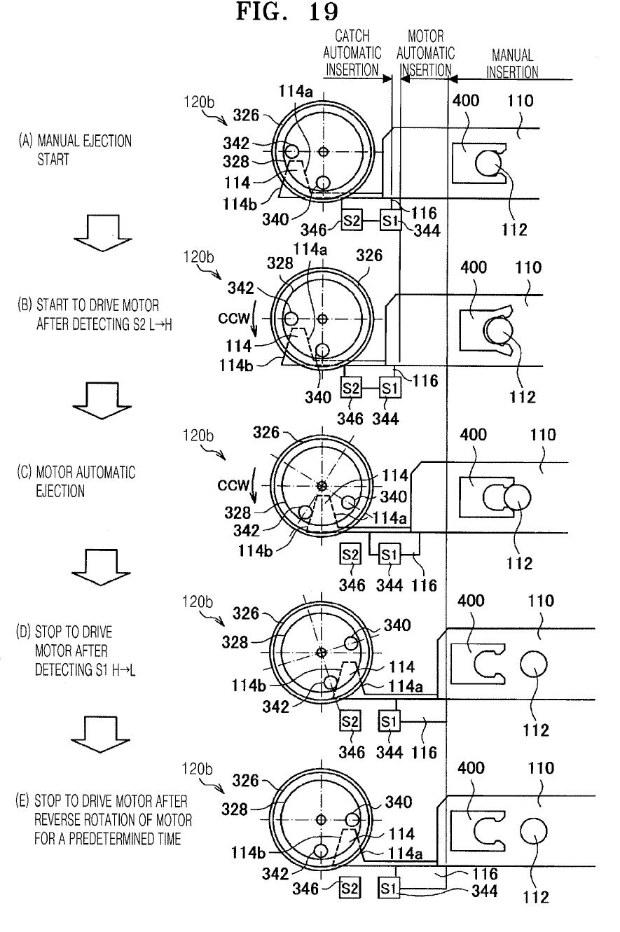

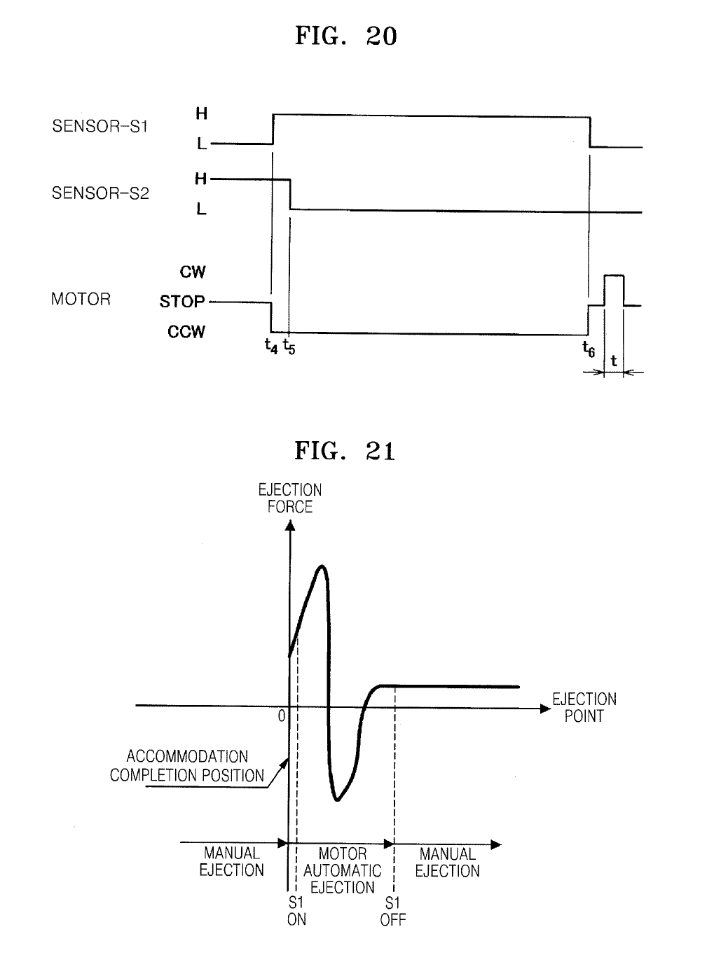

An ejection method of the recording medium tray 110 from the image forming apparatus 10 will be described with reference to FIGS. 19-21. FIGS. 19(A)-19(E) sequentially illustrate the ejection method of the recording medium tray 110, according to an embodiment of the present general inventive concept. FIG. 20 is a timing chart illustrating changes of the outputs of the sensors S1 344 and S2 346 during the ejection of the recording medium tray 110. FIG. 21 is a graph illustrating a relation between the ejection force and the position of the recording medium tray 110 during the ejection, according to an embodiment of the present general inventive concept.

In FIG. 19(A), the engagement portion 112 is connected to the catch 400 as illustrated in FIG. 16(E) and the recording medium tray 110 is accommodated in the image forming apparatus 10. When the recording medium tray 110 is manually pulled out, the shutter 116 enters the slit of the sensor S1 344 as illustrated in FIG. 19(B). Thus, as illustrated in FIG. 20, the output of the sensor S1 344 is changed from the “low (L)” to “high (H)” (at time t4). The driving of the motor 322 is initiated, and thus, the motor 322 pivots in an opposite direction to that of the accommodation method. The roller disc 328 pivots in the direction CCW illustrated in FIG. 19(B).

As illustrated in FIG. 19(C), the roller 342 contacts the inclined surface 114b of the hook 114 to push the hook 114 in the right direction. Thus, the recording medium tray 110 is moved in the right direction so that the recording medium tray 110 can be automatically ejected.

As illustrated in FIG. 19(D), when the recording medium tray 110 is ejected and thus the shutter 116 has exited from the slit of the sensor 344. As illustrated in FIG. 20, the output of the sensor S1 344 is changed from the “high (H)” to the “low (L)” (at time t6) once the shutter 116 exits the slit of the sensor 344. Thus, the driving of the motor 322 is stopped.

In the state illustrated in FIG. 19(D), since the roller 340 is located above the hook 114, even when the driving of the motor 322 is stopped, the recording medium tray 110 can be manually ejected out of the image forming apparatus 10.

As illustrated in FIG. 20, the motor 322 is driven in the opposite direction to that for the automatic ejection only during a particular time T. Accordingly, as illustrated in FIG. 19E, the angular position of the roller disc 328 is returned to the initial state.

In FIG. 21, the position where the output of the sensor S1 344 is changed from the “low (L)” to the “high (H)” at the time point t4 corresponds to the position of S1 ON. Also, the position where the output of the sensor S1 344 is changed from the “low (L)” to the “high (H)” at the time point t6 corresponds to the position of S1 OFF. As illustrated in FIGS. 22 and 24, for the manual ejection, the ejection force changes in the method in which the engagement portion 112 is released from the catch 400. In the present embodiment, however, as illustrated in FIG. 21, during the period from S1 ON to S1 OFF, the recording medium tray 110 can be automatically ejected from the main body of the image forming apparatus 10. Thus, the manipulation can be improved since a relatively large force is not needed for the ejection of the recording medium tray 110.

In the accommodation method or ejection method, even when the insertion force or ejection force of the recording medium tray by the manual operation is applied to the rollers 340 and 342, since the gear 326 and the roller disc 328 function as a friction clutch, the gear 326 and the roller disc 328 relatively pivot. Thus, since the force by the manual operation can be prevented from being transferred to the gear 26, an excess force is not applied to the drive mechanism 120b so that reliability can be improved.

While this present general inventive concept has been particularly illustrated and described with reference to embodiments thereof, it will be understood by one skilled in the art that various changes in form and details may be made therein without departing from the spirit and scope of the general inventive concept as defined by the appended claims.

What is claimed is:

1. A recording medium tray assembly/disassembly mechanism in an image forming apparatus, the recording medium tray assembly/disassembly mechanism comprising:
a sensor to detect an accommodation operation or an ejection operation of a recording medium tray; and
a drive mechanism to connect to the recording medium tray based on a detection by the sensor and to accommodate the recording medium tray at an accommodation complete position or to eject the recording medium tray from the accommodation complete position.

2. The recording medium tray assembly/disassembly mechanism of claim 1, wherein the recording medium tray drive mechanism comprises:
a motor; and
a second connection portion driven by receiving a drive force of the motor and to transfer the drive force of the motor to a first connection portion provided at the recording medium tray.

3. The recording medium tray assembly/disassembly mechanism of claim 2, wherein the recording medium tray drive mechanism comprises:
a first elastic member to elastically press the recording medium tray in an accommodation direction at the accommodation complete position.

4. The recording medium tray assembly/disassembly mechanism of claim 3, wherein, when the ejection operation is performed at the accommodation complete position, as the first elastic member is displaced, the recording medium tray is moved in an ejection direction, and the ejection operation is detected by the sensor.

5. The recording medium tray assembly/disassembly mechanism of claim 4, wherein the recording medium tray drive mechanism comprises:
a second elastic member that is displaced when a manipulation force by the accommodation operation is applied to the drive mechanism.

6. The recording medium tray assembly/disassembly mechanism of claim 5, wherein, when the accommodation operation is performed, as the second elastic member is displaced, the recording medium tray is moved in the accommodation direction, and the accommodation operation is detected by the sensor.

7. The recording medium tray assembly/disassembly mechanism of claim 5, further comprising:
a plurality of members to transfer the drive force of the motor to the second connection portion, wherein the first and second elastic members are provided in a portion where the members relatively move.

8. The recording medium tray assembly/disassembly mechanism of claim 2, further comprising:
a support portion to elastically expand with movement of the recording medium tray at around the accommodation complete position, wherein the recording medium tray is supported in the image forming apparatus by the support portion at the accommodation complete position.

9. The recording medium tray assembly/disassembly mechanism of claim 8, wherein the sensor detects when the recording medium tray arrives approximately at the accommodation complete position during the accommodation of the recording medium tray and the driving of the motor is stopped by the detection.

10. The recording medium tray assembly/disassembly mechanism of claim 2, wherein the driving of the motor is stopped when the sensor detects that the recording medium tray arrives at a position where a connection between the second connection portion and the first connection portion is removed during the ejection of the recording medium tray.

11. The recording medium tray assembly/disassembly mechanism of claim 10, wherein, after the driving of the motor is stopped, the motor rotates in a direction opposite to a motor ejection direction for a predetermined time

12. The recording medium tray assembly/disassembly mechanism of claim 2, further comprising:
at least two members to transfer the drive force of the motor to the second connection portion, wherein the two members function as a friction clutch.

13. An image forming apparatus, comprising:
a recording medium tray assembly/disassembly comprising:
a sensor to detect an accommodation operation or an ejection operation of a recording medium tray; and
a drive mechanism to connect to the recording medium tray based on a detection by the sensor and to accommodate the recording medium tray at an accommodation complete position or to eject the recording medium tray from the accommodation complete position; and
a printing portion printing an image on a sheet of recording medium supplied from the recording medium tray.

14. The image forming apparatus of claim 13, wherein the drive mechanism comprises:
a motor; and
a second connection portion driven by receiving a drive force of the motor and transferring the drive force of the motor to a first connection portion provided in the recording medium tray.

15. The image forming apparatus of claim 14, wherein the drive mechanism comprises:
a first elastic member to elastically press the recording medium tray in an accommodation direction at the accommodation complete position.

16. The image forming apparatus of claim 15, wherein the drive mechanism comprises:
a second elastic member that is displaced when a manipulation force by the accommodation operation is applied to the drive mechanism.

17. The image forming apparatus of claim 16, wherein, when the ejection operation is performed at the accommodation complete position, as the first elastic member is displaced, the recording medium tray is moved in the ejection direction, and the ejection operation is detected by the sensor and, when the accommodation operation is performed, as the second elastic member is displaced, the recording medium tray is moved in the accommodation direction, and the accommodation operation is detected by the sensor.

18. The image forming apparatus of claim 16, further comprising:
a plurality of members to transfer the drive force of the motor to the second connection portion, wherein the first and second elastic members are provided in a portion where the members relatively move.

19. The image forming apparatus of claim 14, further comprising:
a support portion to elastically expand with movement of the recording medium tray at approximately the accommodation complete position, wherein the recording medium tray is supported in the image forming apparatus by the support portion at the accommodation complete position.

20. The image forming apparatus of claim 19, wherein the sensor detects that the recording medium tray arrives approximately at the accommodation complete position during the accommodation of the recording medium tray and the driving of the motor is stopped by the detection.

21. The image forming apparatus of claim 14, wherein the driving of the motor is stopped when the sensor detects that the recording medium tray arrives at a position where a connection between the second connection portion and the first connection portion is removed during the ejection of the recording medium tray.

22. The image forming apparatus of claim 21, wherein, after the driving of the motor is stopped, the motor rotates in a direction opposite to a motor ejection direction for a predetermined time.

23. The image forming apparatus of claim 14, further comprising:
at least two members to transfer the drive force of the motor to the second connection portion, wherein the two members function as a friction clutch.
